(19) United States
(12) Patent Application Publication
(10) Pub. No.: US 2011/0043691 A1
(43) Pub. Date: Feb. 24, 2011

(54) METHOD FOR SYNCHRONIZING VIDEO STREAMS

(76) Inventors: Vincent Guitteny, Paris (FR); Serge Couvet, Jouy Le Moutier (FR); Ryad Benjamin Benosman, Paris (FR)

Correspondence Address: STROOCK & STROOCK & LAVAN LLP, 180 MAIDEN LANE, NEW YORK, NY, 10038, US

(21) Appl. No.: 12/740,853

(22) PCT Filed: Oct. 3, 2008
(86) PCT No.: PCT/EP2008/063273

§ 371 Date: Nov. 8, 2010

(30) Foreign Application Priority Data
Oct. 5, 2007 (FR) 0707007

(51) Int. Cl. H04N 5/04

(52) U.S. Cl. 348/500; 348/E05.009

(57) ABSTRACT

A method for synchronizing at least two video streams originating from at least two cameras having a common visual field. The method includes acquiring the video streams and recording of the images composing each video stream on a video recording medium; rectifying the images of the video streams along epipolar lines; extracting an epipolar line from each rectified image of each video stream; composing an image of a temporal epipolar line for each video stream; computing a temporal shift value δ between the video streams by matching the images of a temporal epipolar line of each video stream for each epipolar line of the video streams; computing a temporal desynchronization value Dₜ between the video streams by taking account of the temporal shift values 6 computed for each epipolar line of the video streams; synchronizing the video streams by taking into account the computed temporal desynchronization value Dₜ.

### CROSS REFERENCE TO PRIOR APPLICATIONS

This application is the U.S. National Phase application under 35 U.S.C. §371 of International Application No. PCT/EP2008/063273, filed on Oct. 3, 2008, and claims benefit to French Patent Application No. 0707007, filed on Oct. 5, 2007, all of which are incorporated by reference herein. The International Application was published on Apr. 9, 2009 as WO 2009/043923.

### BACKGROUND OF THE INVENTION

The present invention relates to a method for synchronizing various video streams. Video stream synchronization is notably used in order to analyze video streams originating from several different cameras filming for example one and the same scene from different viewing angles. The fields of application of video-stream analysis are for example: the monitoring of road traffic, urban security monitoring, the three-dimensional reconstruction of cities for example, the analysis of sporting events, medical diagnosis aid and cinema.

### DESCRIPTION OF THE PRIOR ART

The use of video cameras no longer relates only to the production of cinematographic works. Specifically, a reduction in the price and size of video cameras makes it possible to have many cameras in various locations. Moreover, the increase in the computing power of computers allows the exploitation of complex video acquisition systems comprising multiple cameras. The exploitation of the video acquisition systems comprises a phase of analyzing video data originating from multiple cameras. This analysis phase is particularized according to the field of use of the video data. Amongst the fields commonly using video data analysis are:
road traffic management;
monitoring of public places;
the three-dimensional reconstruction of people in motion;
airborne acquisition for the reconstruction of cities in three dimensions;
medical diagnosis aid;
analysis of sporting events;
aid for decision-making for military or police interventions;
guidance in robotics.

Video data analysis requires synchronization of the video streams originating from the various cameras. For example, a three-dimensional reconstruction of people or of objects is possible only when the dates of shooting of each image of the various video streams are known precisely. The synchronization of the various video streams then consists in temporally aligning video sequences originating from several cameras.

Various methods of synchronizing video streams can be used. The synchronization may notably be carried out by hardware or software. Hardware synchronization is based on the use of dedicated electronic circuits. Software synchronization uses, for its part, an analysis of the content of the images.

Hardware synchronization is based on a very precise control of the triggering of each shot by each camera during acquisition in order to reduce the time interval between video sequences corresponding to one and the same scene shot simultaneously by different cameras.

A first hardware solution commonly implemented uses a connection via a port having a serial interface multiplexed according to IEEE standard 1394, an interface commonly called FireWire, a trademark registered by the Apple company.

Cameras connected together via a data and command bus via their FireWire port can be synchronized very precisely. However, the number of cameras thus connected is limited by the bit-rate capacity of the bus. Another drawback of this synchronization is that it cannot be implemented on all types of cameras.

Cameras connected via their FireWire port to separate buses can be synchronized by an external bus synchronizer developed specifically for camera systems. This type of synchronization is very precise, but it can be implemented only with cameras of one and the same brand.

In general, synchronization via FireWire port has the drawback of being not very flexible to implement on disparate video equipment.

Another hardware solution more commonly implemented uses computers in order to generate synchronization pulses to the cameras, each camera being connected to a computer. The problem with implementing this other solution is synchronizing the computers with one another in a precise manner. This synchronization of the computers with one another can:
either pass through the parallel port of the computers, all the computers being connected together via their parallel port;
or pass through a network, using an Ethernet protocol, to which the computers are connected.
   Ethernet is a packet data transmission protocol used in local area networks which makes it possible to achieve various bit rates that can vary depending on the transmission medium used. In both cases, a master computer sends synchronization pulses to the slave computers connected to the cameras. In the case of the Ethernet network, the master computer is for example the server of the Ethernet network, using an NTP or Network Time Processing protocol. The NTP protocol makes it possible to synchronize clocks of computer systems through a packet data transmission network, the latency of which is variable.

The main drawback of the hardware solutions is as much of a logistical order as financial. Specifically, these hardware solutions require the use of an infrastructure, such as a computer network, which is costly and complex to install. Specifically, the conditions of use of the video acquisition systems do not always allow the installation of such an infrastructure such as for example for urban surveillance cameras: many acquisition systems have already been installed without having provided a place necessary for a synchronization system. It is therefore difficult to synchronize a triggering of all of the acquisition systems present that may for example consist of networks of dissimilar cameras.

Moreover, all the hardware solutions require the use of acquisition systems that can be synchronized externally, which is not the case for mass market cameras for example.

Software synchronization consists notably in carrying out a temporal alignment of the video sequences of the various cameras. Most of these methods use the dynamic structure of the scene observed in order to carry out a temporal alignment of the various video sequences. Several software synchronization solutions can be used.

A first software synchronization solution can be called synchronization by extraction of a plane from a scene. A first method of synchronization by extraction of a plane from a scene is notably described in the document: “Activities From Multiple Video Stream: Establishing a Common Coordinate Frame, IEEE Transactions on Pattern Recognition and Machine Intelligence, Special Section on Video Surveillance and Monitoring, 22 (8), 2000” by Lily Lee, Raquel Romano, Gideon Stein. This first method determines the equation of a plane formed by the trajectories of all the objects moving in the scene. This plane makes it possible to connect all the cameras together. It then involves finding a homographic projection in the plane of the trajectories obtained by the various cameras so that the homographic projection error is minimal. Specifically, the projection error is minimal for synchronous trajectory points corresponding with one another in two video streams. A drawback of this method is that it is not always possible to find a homographic projection satisfying the criterion of minimizing the projection error. Specifically, certain movements can minimize the homography projection error but without being synchronous. This is the case notably for rectilinear movements at constant speed. This method therefore lacks robustness. Moreover, the movement of the objects must take place on a single plane, which limits the context of use of this method to substantially flat environments.

An enhancement of this first synchronization solution is described by J. Kang, I. Cohen, G. Medioni in document “Continuous multi-views tracking using tensor voting, Proceeding of Workshop on Motion and Video Computing, 2002. pp. 181-186”. This enhancement uses two synchronization methods by extraction of a plane from a scene that differ depending on whether or not it is possible to determine the desired homography. In the case in which the homography cannot be determined, an estimate of the synchronization can be made by using epipolar geometry. The synchronization between two cameras is then obtained by intersection of the trajectories belonging to two video streams originating from the two cameras with epipolar straight lines. This synchronization method requires a precise matching of the trajectories; it is therefore not very robust against maskings of a portion of the trajectories. This method is also based on a precalibration of the cameras which is not always possible notably during the use of video streams originating from several cameras installed in an urban environment for example.

A second software synchronization solution is a synchronization by studying the trajectories of objects in motion in a scene.

A synchronization method by studying trajectories of objects is described by Michal Irani in document “Sequence to sequence alignment, Pattern Analysis Machine Intelligence”. This method is based on a pairing of trajectories of objects in a pair of desynchronized video sequences. An algorithm of the RANSAC type for Random Sample Consensus is notably used in order to select pairs of candidate trajectories. The RANSAC algorithm is notably described by M. A. Fischler and R. C. Bolles in document “Random Sample Consensus: A Paradigm for Model Fitting with Applications to Image Analysis and Automated Cartography”, June 1981. The trajectories that are matched by pairing make it possible to estimate a fundamental matching matrix of these trajectories. The quality of the fundamental matrix is all the more correct if the trajectories matched are synchronous. Synchronization is then obtained by an iterative algorithm on the quality of the fundamental matrix.

This method is very sensitive to maskings of certain portions of the trajectories. It is therefore not very robust for a use in environments with a heavy concentration of objects that may or may not be moving. Moreover, the matching of trajectories originating from two cameras is possible only if the two cameras both see the whole of the trajectory.

Another method of synchronization by studying trajectories is described by Khutirumal in document “Video frame alignment in multiple view”. This other method consists in following a point in motion in a sequence filmed by a first camera and carrying out a matching of this point along a corresponding epipolar straight line in an image of the sequence of the second camera.

This other method is not very robust, notably in the case in which the followed point disappears during the movement; it is then not possible to carry out the matching. Moreover, this other method is not very robust to the change of luminosity in the scene, which can be quite frequent for cameras filming outdoors.

A third software synchronization solution is a synchronization by studying singular points of the trajectories of mobile objects of a scene. This solution is notably described by A. Whitehead, R. Laganiere, P. Bose in document “Projective Space Temporal Synchronization of Multiple Video Sequences, Proceeding of IEEE Workshop on Motion and Video Computing, pp. 132-137, 2005”. This involves matching the singular points of the trajectories seen by the various cameras in order to carry out a synchronization. A singular point can be for example a point of inflection on a trajectory that is in the views originating from the various cameras. Once the points of interest have been detected, a synchronization between the sequences originating from the various cameras is obtained by computing the distribution of correlation of all of these points from one sequence to the other.

One of the drawbacks of the third software synchronization solution is that the singular points are usually difficult to extract. Moreover, in particular cases such as oscillating movements or rectilinear movements, the singular points are respectively too numerous or nonexistent. This method is therefore not very effective because it depends too much on the configuration of the trajectories. The trajectories cannot in effect always be constrained. This is notably the case when filming a street scene for example.

A fourth software synchronization solution is a synchronization by studying the changes of luminosity. Such a solution is described by Michal Irani in document “Sequence to sequence alignment, Pattern Analysis Machine Intelligence”. This solution carries out an alignment of the sequences according to their variation in luminosity. This solution makes it possible to dispense with the analysis of objects in motion in a scene which may for example be deprived thereof.

However, the sensors of the cameras are more or less sensitive to the light variations. Moreover, the orientation of the cameras also modifies the perception of the light variations. This fourth solution is therefore not very robust when it is used in an environment where the luminosity of the scene is not controlled. This fourth solution also requires a fine calibration of the colorimetry of the cameras which is not always possible with basic miniaturized cameras.

In general, the known software solutions have results that are not very robust notably when faced with maskings of objects during their movements or require a configuration that is complex or even impossible on certain types of cameras.

### SUMMARY OF THE INVENTION

A general principle of the invention is to take account of the geometry of the scene filmed by several cameras in order to match synchronous images originating from various cameras by pairing in a frequency or spatial domain.

Accordingly, the subject of the invention is a method for synchronizing at least two video streams originating from at least two cameras having a common visual field. The method may comprise at least the following steps:
acquisition of the video streams and recording of the images composing each video stream on a video recording medium;
rectification of the images of the video streams along epipolar lines;
for each epipolar line of the video streams: extraction of an epipolar line from each rectified image of each video stream; for each video stream, all of the epipolar lines extracted from each rectified image comprise, for example, an image of a temporal epipolar line;
for each epipolar line of the video streams: computation of a temporal shift value δ between the video streams by matching the images of a temporal epipolar line of each video stream;
computation of a temporal desynchronization value Dₜ between the video streams by notably taking account of the temporal shift values δ computed for each epipolar line of the video streams;
synchronization of the video streams based on the computed temporal desynchronization value Dₜ.

The matching can be carried out by a correlation of the images of a temporal epipolar line for each epipolar line in a frequency domain.

A correlation of two images of a temporal epipolar line may comprise at least the following steps:
computation of the time gradients of a first and of a second image of a temporal epipolar line, the first and the second image of the temporal epipolar line originating from two video streams;
computation of a Fourier transform of the time gradients of the first and of the second image of the temporal epipolar line;
computation of the complex conjugate of the result of the Fourier transform of the time gradient of the first image of the temporal epipolar line;
computation of the product of the complex conjugate and of the result of the Fourier transform of the time gradient of the second image of the temporal epipolar line;
computation of a correlation matrix by an inverse Fourier transform computation of the result of the product computed during the previous step;
computation of the temporal shift value δ between the two video streams by analysis of the correlation matrix.

The matching can be carried out by a correlation of the images of a temporal epipolar line for each epipolar line in a spatial domain.

A correlation of two images of a temporal epipolar line in a spatial domain may use a computation of a likelihood function between the two images of the temporal epipolar line.

A correlation of two images of the selected temporal epipolar line can be carried out by a decomposition into wavelets of the two images of the temporal epipolar line.

The temporal desynchronization value Dₜ can be computed by taking, for example, a median value of the temporal shift values δ computed for each epipolar line.

Since the acquisition frequencies of the various video streams are, for example, different, intermediate images, for example, created by an interpolation of the images preceding them and following them in the video streams, supplement the video streams of lowest frequency until a frequency is achieved that is substantially identical to that of the video streams of highest frequency.

The main advantages of the invention are notably: of being applicable to a synchronization of a number of cameras that is greater than or equal to two and of allowing a three-dimensional reconstruction in real time of a scene filmed by cameras. This method can also be applied to any type of camera and allows an automatic software synchronization of the video sequences.

### BRIEF DESCRIPTION OF THE DRAWINGS

Other features and advantages of the invention will appear with the aid of the following description given as an illustration and being nonlimiting, and made with respect to the appended drawings which represent:

FIG. 1: a sequence of video images;

FIG. 2: a temporal matching of images originating from two sequences of video images;

FIG. 3: an example of epipolar rectification of two images;

FIG. 4: an example of extraction of an epipolar line from volumes of rectified images according to the invention;

FIG. 5: various possible steps of an algorithm for matching images of temporal epipolar lines in the frequency domain according to the invention;

FIG. 6: an example of matching two images of temporal epipolar lines in the frequency domain by obtaining a correlation image;

FIG. 7: an example of matching images of temporal epipolar lines in the frequency domain for two different temporal shifts;

FIG. 8: various possible steps of the method for synchronizing video streams according to the invention.

### DETAILED DESCRIPTION

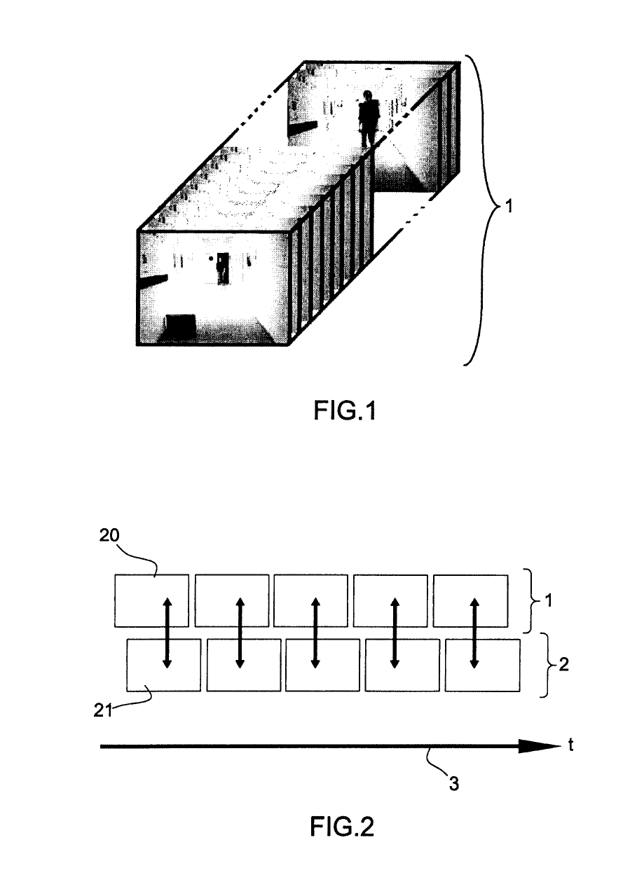

FIG. 1 represents a first video sequence 1 originating from a first camera filming a scene. The first video sequence is, for example, a series of images acquired at regular intervals over time by the first camera. The first camera can be the central projection type of camera such as perspective cameras, cameras with or without distortion or catadioptric systems. The first camera may also be a noncentral projection camera such as the catadioptric systems based on a spherical mirror.

The present invention applies to achieving a software synchronization of at least two video sequences originating from at least two cameras. The two cameras may be of different types. The application of the invention is not limited to the synchronization of two cameras; it is also applicable to the synchronization of a number n of video streams or video sequences originating from a number n of cameras, n being greater than or equal to two. However, to simplify the description of the invention, the rest of the description will focus on only two cameras. The two cameras to be synchronized by means of the invention by and large observe one and the same scene. Specifically, it is necessary for a portion of each scene observed by each camera to be common to both cameras. The size of the common portion observed by the two cameras is not determinant for the application of the invention, so long as it is not empty.

FIG. 2 represents a general principle of a software synchronization of two video sequences 1, 2, or video streams 1, 2, which are for example digital. A first video sequence 1 originates from a first camera, and a second video sequence may originate from a second camera. In general, the two cameras are video sensors. The software synchronization applies to temporally readjusting each image acquired by a network of cameras on one and the same temporal axis 3. For example, in FIG. 2, the temporal synchronization of the video streams 1, 2 makes it possible to match a first image 20 of the first video sequence 1 with a second image 21 of the second video sequence 2. The second image 21 represents the same scene as the first image 20 seen for example from a different angle. The first image 20 and the second image 21 therefore correspond to one and the same moment of shooting.

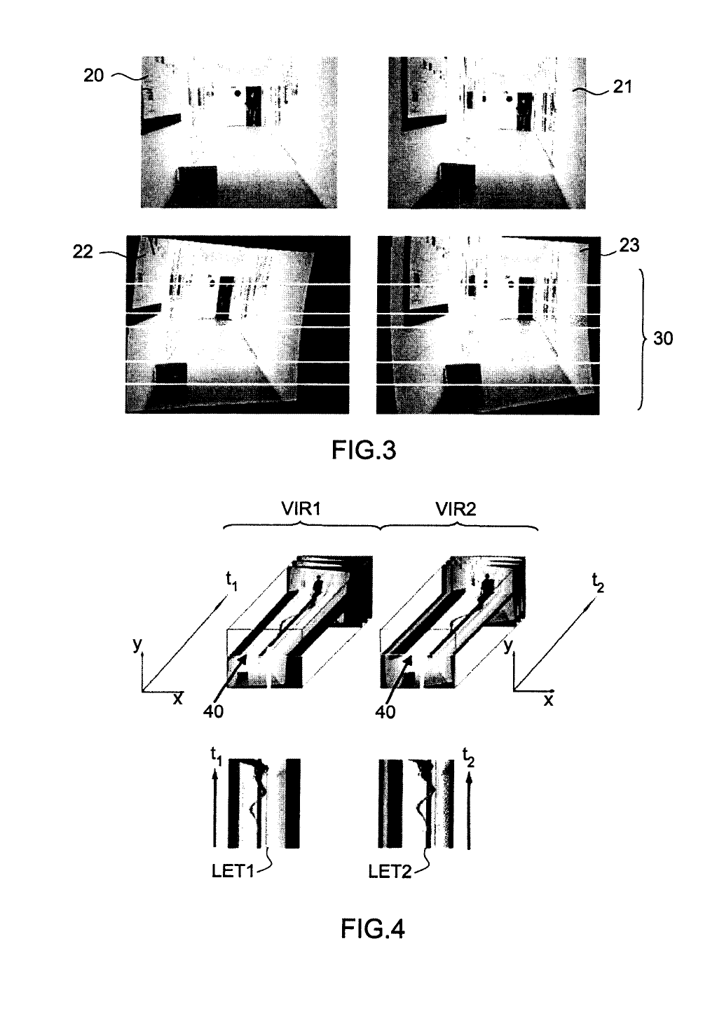

FIG. 3 represents an example of rectification of images. The invention is a software method of synchronizing images in which the first step is notably a matching of the images of the two video streams 1, 2. The matching of the original two images 20, 21 of the video streams 1, 2 can use an epipolar rectification of the two original images 20, 21. An epipolar rectification of two images is a geometric correction of the two original images 20, 21 so as to geometrically align all the pixels of the first original image 20 with the corresponding pixels in the second original image 21. Therefore, once the two original images 20, 21 have been rectified, each pixel of the first original image 20 and the pixel corresponding thereto in the second original image 21 are on one and the same line. This same line is an epipolar line. Two pixels of two different original images 20, 21 correspond to one another when they represent a projection in an image plane of one and the same point in three dimensions of the filmed scene. FIG. 3 represents, on the one hand, the two original images 20, 21 and, on the other hand, the two rectified images 22, 23 on the epipolar lines 30. The two rectified images 22, 23 are notably obtained by matching the pixels of the first original image 20 with the pixels of the second original image 21. In FIG. 3, for example, five epipolar lines 30 are shown.

The epipolar rectification of the images originating from two different cameras makes it possible to ascertain a slight calibration of the two cameras. A slight calibration makes it possible to estimate the relative geometry of the two cameras. The slight calibration is therefore determined by a matching of a set of pixels of each original image 20, 21 as described above. This matching may be automatic or manual, using a method of calibration by test chart for example, depending on the nature of the scene observed. Two matching pixels between two original images 20, 21 satisfy the following relation:

x′^{t}Fx=0 (100)

in which F is a fundamental matrix representative of the slight calibration of the two cameras, x′^{t} is, for example, the conversion of the vector of Cartesian coordinates of a first pixel in the plane of the first original image 20, x is, for example, the vector of Cartesian coordinates of the second corresponding pixel in the plane of the second original image 21. The relation (100) is explained in greater detail by Richard Hartley and Andrew Zisserman in the work: “Multiple View Geometry, second edition”.

Many existing methods make it possible to estimate the fundamental matrix F notably based on rigid points that are made to match from one camera to the other. A rigid point is a fixed point from one image to the other in a given video stream.

First of all, in order to ensure that the selected rigid points do not form part of objects in motion, the static background of the image is extracted. Then the rigid points are chosen from the static background of the extracted image. The fundamental matrix is then estimated based on the extracted static background images. The extraction of the static background of the image can be carried out according to a method described by Qi Zang and Reinhard Klette in the document “Evaluation of an Adaptive Composite Gaussian Model in Video Surveillance”. This method makes it possible to characterize a rigid point in a scene via a temporal Gaussian model. This therefore makes it possible to extract a pixel map, called a rigid pixel map, from an image. The user then applies to this rigid map algorithms of structure and of movement which make it possible:
to detect and describe rigid characteristic points in the scene;
to match the rigid characteristic points in two images of two video streams;
to estimate a fundamental matrix by robust algebraic methods such as the RANSAC algorithm or the method of the least median of squares associated with an M-estimator.

The slight calibration of two cameras can also be obtained by using a characteristic test chart in the filmed scene. This method of slight calibration can be used in cases in which the method described above does not give satisfactory results.

The rectification of images has the following particular feature: any pixel representing a portion of an object in motion in the first original image 20 of the first video stream 1 is on the same epipolar line 30 as the corresponding pixel in the second original image 21 of the second video stream 2 when the two images are synchronous. Consequently, if an object in motion passes at a moment t on an epipolar line of the first original image 20 of the first camera, it will traverse the same epipolar line 30 in the second original image 21 of the second camera when the first and the second original image 20, 21 are synchronized. The method according to the invention judiciously uses this particular feature in order to carry out a synchronization of two video sequences by analyzing the variations comparatively between the two video streams 1, 2 of the epipolar lines 30 in the various images of the video streams 1, 2. The variations of the epipolar lines 30 are for example variations over time of the intensity of the image on the epipolar lines 30. These variations of intensity are for example due to objects in motion in the scene. The variations of the epipolar lines 30 may also be variations in luminosity of the image on the epipolar line 30.

The method according to the invention therefore comprises a step of rectification of all of the images of the two video streams 1, 2. This rectification amounts to deforming all the original images of the two video streams 1, 2 according to the fundamental matrix so as to make the epipolar lines 30 parallel. In order to rectify the original images, it is possible, for example, to use a method described by D. Oram in the document: “Rectification for Any Epipolar Geometry”.

FIG. 4 represents an example of extraction according to the invention of an epipolar line 40 from the two streams of video images 1, 2, once the images have been rectified. An image of a temporal epipolar line, called the epipolar image in the rest of the description, is an image LET1, LET2 formed by the temporal assembly, in chronological order of shooting, of the pixels of one and the same epipolar line 40 extracted from each rectified image 22, 23 of each video stream 1, 2. The set of rectified images 22, 23 of a video stream 1, 2 is also called a volume of rectified images. The volume of rectified images of the first video stream 1 is the first volume of rectified images VIR1 shown in FIG. 4. In the same manner, the volume of rectified images of the second video stream 2 is the second volume of rectified images VIR2 represented in FIG. 4. The rectified images 22, 23 of the volumes of rectified images VIR1, VIR2 are temporally ordered in the chronological order of shooting for example. The first volume of rectified images VIR1 is therefore oriented on a first temporal axis t₁ and the second volume of rectified images VIR2 is oriented on a second temporal axis t₂ that differs from t₁. Specifically, the volumes of rectified images VIR1, VIR2 are not yet synchronized; they therefore do not follow the same temporal axis t₁, t₂. An epipolar image LET1, LET2 is obtained by a division of a volume of rectified images VIR1, VIR2 on a plane defined by the epipolar line 40 and substantially parallel to a first horizontal axis x, the plane being substantially perpendicular to a second vertical axis y. The second vertical axis y is substantially perpendicular to the first axis x. A first epipolar image LET1 is therefore obtained from the first volume of rectified images VIR1. The first epipolar image LET1 is therefore obtained by making a cut of the first volume of rectified images VIR1 on the epipolar line 40 perpendicularly to the second vertical axis y. In the same manner, a second epipolar image LET2 is obtained by making a cut of the second volume of rectified images VIR2 on the epipolar line 40, perpendicularly to the second vertical axis y.

The epipolar images LET1, LET2 make it possible to study the evolution of the epipolar line 40 over time for each video stream 1, 2. Studying the evolution of the temporal epipolar lines makes it possible to match the traces left in the images of the video streams 1, 2 by objects in motion in the scene filmed.

In order to carry out a synchronization of the two video sequences 1, 2, an extraction of each epipolar line 30 from each image of the two volumes of rectified images VIR1, VIR2 is carried out. This therefore gives as many pairs of epipolar images (LET1, LET2) as there are epipolar lines in an image. For example, it is possible to extract an epipolar image for each line of pixels comprising information in a rectified image 22, 23.

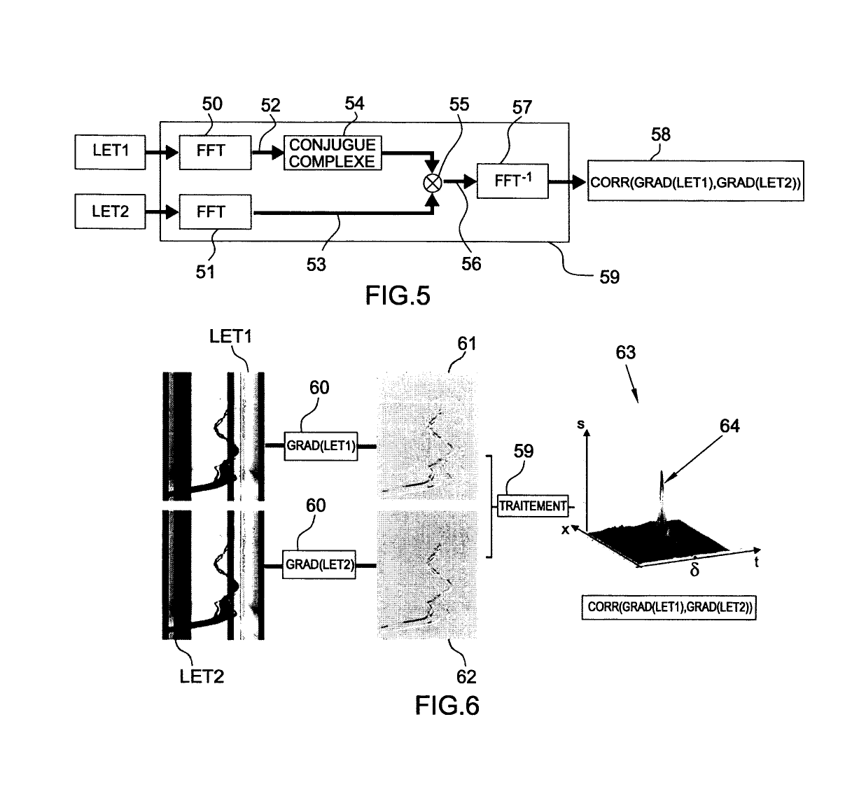

FIG. 5 shows an example of an algorithm for matching the epipolar images LET1, LET2 in the frequency domain, according to the invention.

The algorithm for matching the epipolar images LET1, LET2 can use a process based on Fourier transforms 59.

A discrete Fourier transform, or FFT, 50, 51 is applied to a time gradient of each epipolar image LET1, LET2. This makes it possible to dispense with the background of the scene. Specifically, a time gradient applied to each epipolar image LET1, LET2 amounts to temporally shifting the epipolar images LET1, LET2 and thus makes it possible to reveal only the contours of the movements of the objects in motion in the filmed scene. The time gradient of an epipolar image is marked GRAD(LET1), GRAD(LET2). A first Fourier transform 50 applied to the first time gradient GRAD(LET1) of the first epipolar image LET1 gives a first signal 52. A second Fourier transform 51 applied to the second time gradient GRAD(LET2) of the second epipolar image LET2 gives a second signal 53. Then, a product 55 is made of the second signal 53 with a complex conjugate 54 of the first signal 52. The result of the product 55 is a third signal 56. Then an inverse Fourier transform 57 is applied to the third signal 56. The result of the inverse Fourier transform 57 is a first correlation matrix 58 CORR(GRAD(LET1),GRAD(LET2)).

FIG. 6 represents images obtained at different stages of the matching of the two epipolar images LET1, LET2 in the frequency domain. The application of a time gradient 60 to the epipolar images LET1, LET2 gives two gradient images 61, 62. The first gradient image 61 is obtained by taking a first time gradient GRAD(LET1) of the first epipolar image LET1. The second gradient image 62 is obtained by taking a second time gradient GRAD(LET2) of the second epipolar image LET2. The Fourier transform process 59 shown in greater detail in FIG. 5 is therefore applied to the two gradient images 61, 62. The first correlation matrix CORR(GRAD(LET1),GRAD(LET2)), obtained as the output of the process 59, can be represented in the form of a correlation image 63. The correlation image 63 can be represented in the form of a three-dimensional image (x, t, s), in which x represents the first horizontal axis x, t a third temporal axis, and s a fourth axis representing a correlation score. A temporal shift δ between two epipolar images LET1, LET2 is measured on the third temporal axis t. Specifically, for a temporal shift t=δ, a correlation peak 64 is observed in the correlation image 63. The correlation peak 64 is reflected in the correlation image 63 by a high value of the correlation score for t=δ. The correlation peak 64 corresponds to the optimal shift between the traces left by the objects in motion.

Each pair of epipolar images (LET1, LET2) extracted from the volumes of rectified images VIR1, VIR2 therefore makes it possible to estimate a temporal shift δ between the two video streams 1, 2.

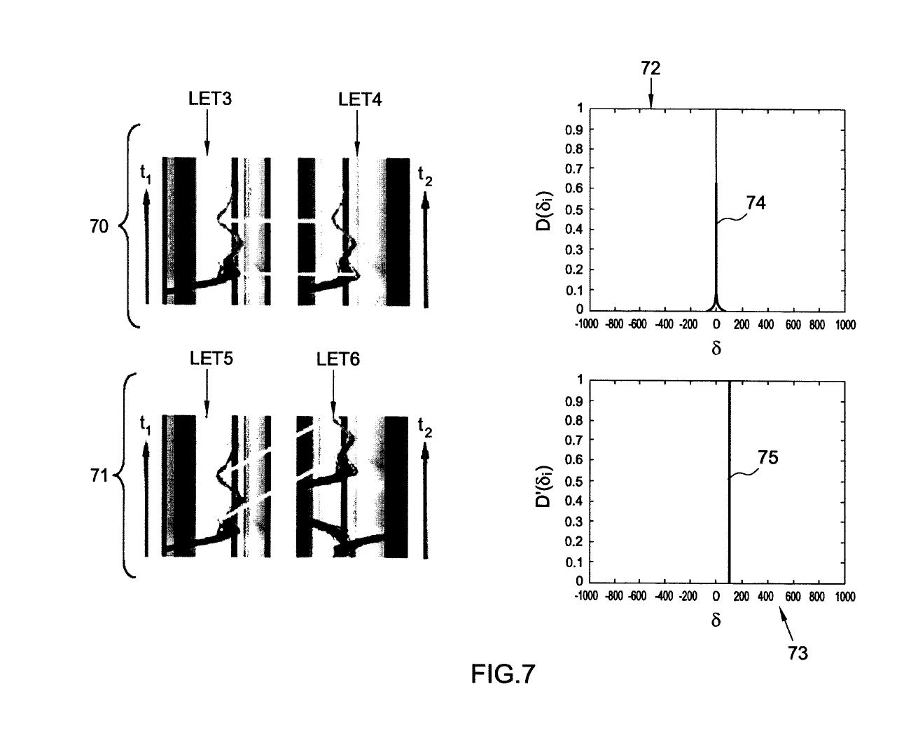

FIG. 7 represents two examples 70, 71 of matching video streams having a different temporal shift, according to the invention.

A first example 70 shows a first pair of epipolar images (LET3, LET4) out of n pairs of epipolar images coming from a second and a third video stream. From each pair of epipolar images, by applying the process 59 to the gradients of each epipolar image GRAD(LET3), GRAD(LET4) for example, a correlation matrix CORR(GRAD(LET3), GRAD(LET4)) for example is obtained. In general, it can be noted that:

CORRᵢ=FFT⁻¹(FFT(GRAD(LETi₁)×FFT*(GRAD(LETi₂)) (101)

where i is an index number of a pair of epipolar images out of n pairs of epipolar images, LETi₁ is an nth epipolar image of the second video stream, LETi₂ is an nth epipolar image of a third video stream.

After computing all of the correlation images CORRᵢ for the n pairs of epipolar images (LET3, LET4) of the second and of the third video stream, a set of n temporal shifts δᵢ is obtained. There is therefore one temporal shift δᵢ per pair of epipolar images (LET3, LET4). In the first graph 72, a distribution D(δᵢ) of the temporal shifts δᵢ according to the values t of δᵢ is shown. This distribution D(δᵢ) makes it possible to compute a temporal desynchronization Dₜ in a number of images for example between the third and the fourth video stream for example. Dₜ is for example obtained in the following manner:

Dₜ=medianⁿᵢ₌₁(δᵢ) (102)

where median is the median function. Dₜ is therefore a median value of the temporal shifts δᵢ.

In the first graph 72, the median value Dₜ is represented by a first peak 74 of the first distribution D(δᵢ). The first peak 74 appears for a zero value of t, the third and fourth video streams are therefore synchronized; specifically in this case, the temporal desychronization Dₜ is zero images.

In a second example 71, a third correlation matrix CORR(GRAD(LET5),GRAD(LET6)) is obtained by the process 59 applied to a temporal gradient of the epipolar images of a second pair of epipolar images (LET5, LET6) originating from a fifth and a sixth video stream. By computing the correlation images relative to all of the pairs of epipolar images originating from the fifth and sixth video streams, a second graph 73 is obtained in the same manner as in the first example 70. The second graph 73 shows on the abscissa the temporal shift δ between the two video streams and on the ordinate a second distribution D′(δᵢ) of the temporal shift values δᵢ obtained according to the computed correlation matrices. In the second graph 73, a second peak 75 appears for a value of δ of one hundred. This value corresponds, for example, to a temporal desynchronization Dₜ between the fifth and sixth video streams equivalent to one hundred images.

The computed temporal desynchronization Dₜ is therefore a function of all of the epipolar images extracted from each volume of rectified images of each video stream.

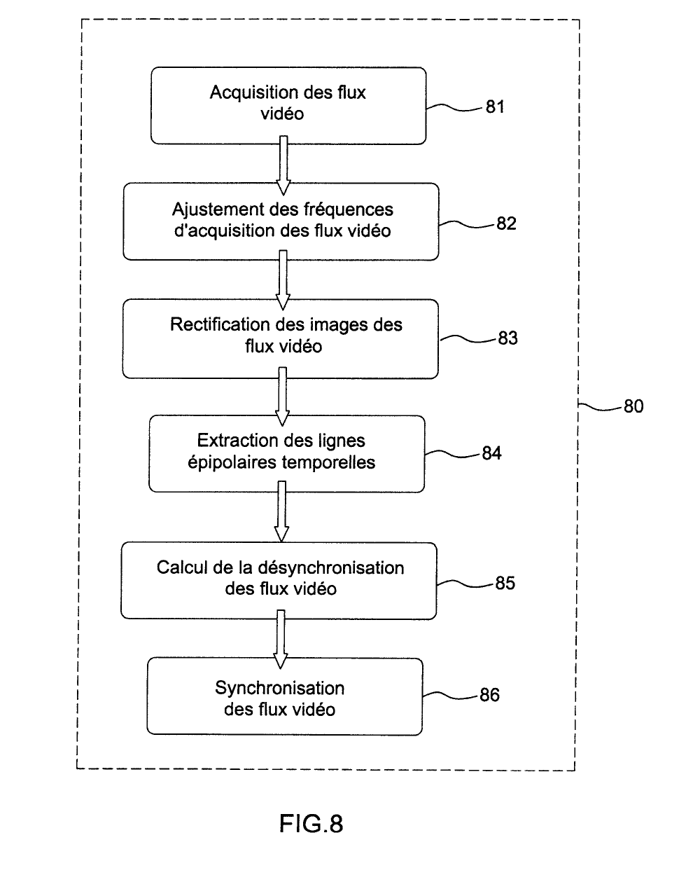

FIG. 8 represents several possible steps 80 of the method for synchronizing video streams 1, 2 according to the invention.

A first step 81 is a step of the acquisition of video sequences 1, 2 by two video cameras. The acquired video sequences 1, 2 can be recorded on a digital medium, for example like a hard disk, a compact disk, or on a magnetic tape. The recording medium being suitable for the recording of video-stream images.

A second step 82 is an optional step of adjusting the shooting frequencies if the two video streams 1, 2 do not have the same video-signal sampling frequency. An adjustment of the sampling frequencies can be carried out by adding images into the video stream that has the greatest sampling frequency until the same sampling frequency is obtained for both video streams 1, 2. An image added between two images of a video sequence can be computed by interpolation of the previous image and of the next image. Another method can use an epipolar line in order to interpolate a new image based on a previous image in the video sequence.

A third step 83 is a step of rectification of the images of each video stream 1, 2. An example of image rectification is notably shown in FIG. 3.

A fourth step 84 is a step of extraction of the temporal epipolar lines of each video stream 1, 2. The extraction of the temporal epipolar lines is notably shown in FIG. 4. In each video stream, all of the epipolar lines 30 are extracted. It is possible, for example, to extract one temporal epipolar line for each line of pixels in a video-stream image.

A fifth step 85 is a step of computing the desynchronization between the two video streams 1, 2. The computation of the desynchronization between the two video streams 1, 2 amounts to matching the pairs of images of each temporal epipolar line extracted from the two video streams 1, 2 like the first and the second epipolar image LET1, LET2. This matching can be carried out in the frequency domain as described above by using a Fourier transform process 59. A matching of two epipolar images can also be carried out by using a technique of dividing the epipolar images into wavelets.

A matching of each pair of epipolar images (LET1, LET2) can be carried out also in the spatial domain. For example, for a pair of epipolar images (LET1, LET2), a first step of matching in the spatial domain allows a computation of a main function representing ratios of correlation between the two epipolar images. A main function representing ratios of correlation is a probability function giving an estimate, for a first data set, of its resemblance to a second data set. The resemblance is, in this case, computed for each data line of the first epipolar image LET1 with all the lines of the second epipolar image LET2, for example. Such a measurement of resemblance, also called a likelihood measurement, makes it possible to obtain directly a temporal matching between the sequences from which the pair of epipolar images (LET1, LET2) originated.

According to another embodiment, a matching of two epipolar images LET1, LET2 can be carried out by using a method according to the prior art such as a study of singular points.

Once the matching has been carried out, the value obtained for the temporal desynchronization between the two video streams 1, 2, the latter are synchronized according to conventional methods during a sixth step 86.

The advantage of the method according to the invention is that it allows a synchronization of video streams for cameras producing video streams that have a reduced common visual field. It is sufficient, for the method according to the invention to be effective, that the common portions between the visual fields of the cameras are not zero.

The method according to the invention advantageously synchronizes video streams even in the presence of a partial masking of the movement filmed by the cameras. Specifically, the method according to the invention analyzes the movements of the images in their totality.

For the same reason, the method according to the invention is advantageously effective in the presence of movements of small amplitudes of objects that are rigid or not situated in the field of the cameras, a nonrigid object being a deformable soft body.

Similarly, the method according to the invention is advantageously applicable to a scene comprising large-scale elements and reflecting elements such as metal surfaces.

The method according to the invention is advantageously effective even in the presence of changes of luminosity. Specifically, the use of a frequency synchronization of the images of the temporal epipolar lines removes the differences in luminosity between two images of one and the same temporal epipolar line.

The correlation of the images of temporal epipolar lines carried out in the frequency domain is advantageously robust against the noise present in the images. Moreover, the computation time is independent of the noise present in the image; specifically, the method processes the images in their totality without seeking to characterize particular zones in the image. The video signal is therefore processed in its totality.

Advantageously, the use by the method according to the invention of a matching of all the traces left by objects in motion on the epipolar lines is a reliable method: this method does not constrain the nature of the scene filmed. Specifically, this method is indifferent to the size of the objects, to the colors, to the maskings of the scene such as trees, or to the different textures. Advantageously, the correlation of the temporal traces is also a robust method.

The method according to the invention is advantageously not very costly in computation time. It therefore makes it possible to carry out video-stream processes in real time. Notably, the correlation carried out in the frequency domain with the aid of Fourier transforms allows real time computation. The method according to the invention can advantageously be applied in post-processing of video streams or in direct processing.

The video streams that have a high degree of desynchronization, for example thousands of images, are effectively processed by the method according to the invention. Specifically, the method is independent of the number of images to be processed in a video stream.

1. A method for synchronizing at least two video streams originating from at least two cameras having a common visual field, the method comprising:
acquiring the video streams and recording of the images composing each video stream on a video recording medium;
rectifying the images of the video streams along epipolar lines;
for each epipolar line of the video streams: extracting an epipolar line from each rectified image of each video stream; for each video stream, all of the epipolar lines extracted from each rectified image composing an image of a temporal epipolar line;
for each epipolar line of the video streams: computing a temporal shift value δ between the video streams by matching the images of a temporal epipolar line of each video stream;
computing a temporal desynchronization value Dₜ between the video streams by taking account of the temporal shift values δ computed for each epipolar line of the video streams;
synchronizing the video streams based on the computed temporal desynchronization value Dₜ.

2. The method as claimed in claim 1, wherein the matching is carried out by a correlation of the images of a temporal epipolar line for each epipolar line in a frequency domain.

3. The method as claimed in claim 2, wherein a correlation of two images of a temporal epipolar line comprises:
computing the time gradients of a first and of a second image of a temporal epipolar line, the first and the second image of the temporal epipolar line originating from two video streams;
computing a Fourier transform of the time gradients of the first and of the second image of the temporal epipolar line;
computing the complex conjugate of the result of the Fourier transform of the time gradient of the first image of the temporal epipolar line;
computing the product of the complex conjugate and of the result of the Fourier transform of the time gradient of the second image of the temporal epipolar line;
computing a correlation matrix by an inverse Fourier transform computation of the result of the product computed during the previous step;
computing the temporal shift value δ between the two video streams by analysis of the correlation matrix.

4. The method as claimed in claim 1, wherein the matching is carried out by a correlation of the images of a temporal epipolar line for each epipolar line in a spatial domain.

5. The method as claimed in claim 4, wherein a correlation of two images of a temporal epipolar line in a spatial domain uses a computation of a likelihood function between the two images of the temporal epipolar line.

6. The method as claimed in claim 1, wherein a correlation of two images of the selected temporal epipolar line is carried out by a decomposition into wavelets of the two images of the temporal epipolar line.

7. The method as claimed in claim 1, wherein the temporal desynchronization value Dₜ is computed by taking a median value of the temporal shift values δ computed for each epipolar line.

8. The method as claimed in claim 1, wherein since the acquisition frequencies of the various video streams are different, intermediate images, created by an interpolation of the images preceding them and following them in the video streams, supplement the video streams of lowest frequency until a frequency is achieved that is substantially identical to that of the video streams of highest frequency.
